(19) United States
(12) Patent Application Publication
(10) Pub. No.: US 2006/0253860 A1
(43) Pub. Date: Nov. 9, 2006

(54) Systems and methods for interfacing an application of a first type with multiple applications of a second type

(75) Inventors: Dale E. Hoerle, Naperville, IL (US); Jeffery K. Hensley, Genoa, IL (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: The TriZetto Group, Inc., Greenwood Village, CO (US)

(21) Appl. No.: 11/124,770

(22) Filed: May 9, 2005

(51) Int. Cl. G06F 9/46

(52) U.S. Cl. 719/328

(57) ABSTRACT

Disclosed are systems and methods which provide an interface for disparate software applications using an adapter associated with at least one application of a first type to interface the first application with multiple applications of a second type, each of which has an associated adapter. A first adapter may be associated with a first software application, such as a claim processing software application. The present invention may enable the first software application to interact with a plurality of different applications of a second type, such as a plurality of different types of case management software applications that may be implemented within an insurer's organization.

### CROSS-REFERENCE TO RELATED APPLICATIONS

The present invention is related to co-pending and commonly assigned U.S. patent application Ser. No. 10/965,253 entitled “INTERFACING DISPARATE SOFTWARE APPLICATIONS”, filed Oct. 14, 2004”; and U.S. patent application Ser. No. [66729-P010US-10405933], filed concurrently, herewith, entitled “SYSTEMS AND METHODS FOR INTERFACING A COMPONENT SOLUTION WITH ONE OR MORE APPLICATIONS OF A PARTICULAR TYPE”; the disclosures of which are hereby incorporated herein by reference.

### TECHNICAL FIELD

The present invention relates generally to providing interfacing between disparate software systems using adapters and, more particularly, to using an adapter associated with a first application of a first type to interface the first application with multiple applications of a second type, each of which has an associated adapter.

### BACKGROUND OF THE INVENTION

Enterprises, such as business enterprises, governmental agencies, and private enterprises, often employ a number of systems, whether hardware, software, or combinations thereof, for providing functionality useful to the operation of the enterprise. For example, an enterprise may employ a complex computer network and communication system in order to facilitate information communication, processing, storage, analysis, modeling, etcetera. The aforementioned computer network may provide desired functionality through the use of various software systems, such as may comprise one or more software applications (referred to herein as applications) addressing particular aspects of the enterprise operations.

As but one example, for an enterprise providing healthcare services such applications may include one or more case management applications, credentialing applications, financial applications, membership management applications, commissions applications, customer service applications, provider network management applications, claims processing applications, adjudication applications, etcetera. Efficient operation of the enterprise may suggest that information from one such application should be exchanged (advantageously in real-time) with multiple applications of another type. However, each application may utilize a proprietary data format, incompatible data inputs/outputs, or otherwise present barriers to their directly interfacing for desired information exchange making these applications not only disparate with respect to function but also disparate with respect to interfacing.

Further compounding the difficulties associated with the ability to provide information exchange between such an enterprise's applications, an enterprise may utilize more than one of any or all of the foregoing applications, wherein one or more applications providing a same or similar function may also be disparate. This may happen due to growth or expansion of a enterprise, or through acquisition or merger. For example, a healthcare services enterprise may acquire or merge with another healthcare services enterprise, each having a number of systems, including different ones of the foregoing applications, for providing functionality useful to the operation of the enterprise. Thus, for example, an insurer (an example of a healthcare services enterprise) may comprise a plurality of disparate claims processing applications. Migration to one platform is likely to be costly and time consuming. Therefore, for at least a time, various legacy application may be used in parallel with other applications providing the same or similar functionality.

Approaches to providing integration between enterprise applications have included Enterprise Application Integration (EAI) efforts which typically result in an EAI application uniquely tailored to a situation to provide interfacing between a plurality of specific enterprise applications. For example, an EAI application will typically be adapted to interface with particular enterprise applications and will provide a data path between particular ones of these applications (e.g., point-to-point interfacing). EAI applications have provided enterprise application interfacing in batch processing modes or in real-time processing modes, but heretofore have not offered a combination of batch processing and real-time processing.

EAI applications are generally a centralized application requiring considerable resources and manpower to operate and maintain. Although the software applications themselves often provide stable and reliable operation, EAI applications tend to be less stable and present reliability issues with respect to the application interfaces provided thereby failing or degrading. There has heretofore been no ability to monitor the performance of interfaces provided by EAI applications or to validate that they are working, without an operator actually monitoring the operation of the interfaces.

Moreover, EAI applications typically adopt a “stove pipe” configuration wherein they implement proprietary data interchange architecture and are adapted for use with only specific applications. Thus, traditional interfaces have been built on a point to point basis. In a healthcare services environment, to interface an adjudication application with a case management application, an interface between those two particular applications has traditionally been employed. If this example system employs more than one case management application separate interfaces to connect each of theses case management applications to the adjudication system would typically need to be developed and maintained. Therefore, if, by way or example, a plurality of different legacy case management applications are to be connected to a single adjudication application using an EAI application, the EAI applications would need to be developed for each of these links, separately. In other words, if three case management applications are to be connected to a single adjudication engine, three unique two-way EAI application protocols would need to be developed, implemented and maintained.

Also, if an enterprise, using a typical EAI application to provide interfacing between applications, changes, adds, or removes an application, the interface provided will be broken. Therefore, the EAI application will require corresponding modification, such as to add a new interface or modify an existing interface in order to support changes with respect to the enterprise applications. Such EAI application modifications are typically costly and time consuming, resulting in a reluctance, or an inability, to implement enterprise application changes.

### SUMMARY

The present invention is directed to systems and methods which use an adapter associated with a first application of a first type to interface the first application with multiple applications of a second type, each of which employ its own adapter. For example, an adapter that is associated with a first software application, such as a claim processing software application, may be used to enable the first software application to interact with a plurality of different applications of a second type, such as a plurality of different types of case management software applications that may be implemented within an insurer's organization. As another example, a central case management application can interact with multiple claims adjudication engines, such as may have been previously associated with other healthcare services providers, or the like.

Adapters of embodiments of the present systems and methods may be associated with, or specifically designed for, an enterprise function or “business process,” rather than having a one-to-one association with the applications for which interfacing is provided. For example, embodiments of the present systems and methods provide adapters for use in healthcare services enterprises, such as may employ one or more case management applications, credentialing applications, financial applications, membership management applications, commissions applications, customer service applications, provider network management applications, claims processing applications, etcetera. However, rather than providing an adapter for each application-to-application link, embodiments of the present systems and methods provide adapters for particular business processes or functions facilitated using one or more applications.

The present systems and methods may employ adapters associated with a first application that take into account requirements of another type of application in a “holistic” manner to thereby provide an adapter associated with the first application, such as a claims adjudication engine, that can interact with multiple applications of a particular other type, such as case management applications which may have been provided by different vendors, have been previously associated with other healthcare services providers, are of different versions, or otherwise differ. Conversely, a central case management application can interact with multiple claims adjudication engines in accordance with the present invention.

According to embodiments of the present invention, adapters provide a decentralized architecture using a common communication bus protocol. For example, an embodiment of a first adapter may be adapted for proprietary data communication with an associated first application, thereby providing information communication suitable for establishing a first end of a software application information communication link. Additionally, this adapter is preferably adapted for data communication with other adapters, using protocols common to each such adapter. Other applications, which may be of a type differing from the first application may each employ an adapter in accordance with embodiments of the present systems and methods, which is adapted for proprietary data communication with its associated application. Thereby, each of these other adapters may provide information communication suitable for establishing another end of a software application information communication link. Each of these adapters are also preferably adapted for data communication with other adapters, such as the first adapter, using protocols common to all of the adapters.

According to various embodiments of the present systems and methods, the common protocols utilized for inter-adapter communications may comprise an open or standardized protocol, such as the extensible markup language (XML), simple object access protocol (SOAP), web services description language (WSDL), universal description, discovery and integration (UDDI), and/or the like, as a common communication bus protocol. For example, web services protocols, providing a standardized way of integrating web-based applications, may be used according to embodiments of the present systems and methods. For example, an embodiment of the present systems and methods implements a web services module to facilitate an open architecture real-time information communication platform supporting calls between adapters. Batch information communication may be provided through publishing information by one or more adapter. The foregoing information may be published in a number of different ways according to embodiments of the present systems and methods, such as to a database, to a message queue, to a flat file, etcetera. An application (or adapter associated therewith) requesting the information from another application can specify how the information is to be published, according to embodiments of the systems and methods. Moreover, using adapters of the present systems and methods, embodiments support various publication types, even though the application from which the information is published may not support the requested publication type (e.g., device type to which the information is published, format of the publication, the way in which the information is published, etcetera).

Using adapters of embodiments of the present systems and methods, software applications may be changed, e.g., added, replaced, removed, etcetera, without affecting the information communication links between the applications of the aforementioned first and second types. Additionally, such changed applications may be readily accommodated by providing an adapter or adapters configured for information communication with the changed application, without a need arising to change the adapters used by the other applications of the same or different types. To update an adapter to account for a change in the associated application, a programmer need only be familiar with the interface to the associated application and the generic format used with respect to the common communication bus. The programmer need not be familiar with the interface to other applications with which the associated application is to interface, or even the particular applications the associated application is to interface.

An embodiment of a system of the present invention might comprise a first adapter providing communication with a first application in a format native to the first application. This first adapter may also provide communication in an adapter common communication bus format. A second adapter provides communication with a second application in a format native to the second application and provides communication in the adapter common communication bus format. The second application may be of a type differing from the first application. A third adapter provides communication with a third application and also provides communication in the adapter common communication bus format. The third application is a same type of application as the second application.

Preferably, the first adapter transforms a function performed by the first application to a function having a generic format, and each of the second and third adapters transforms the function having the generic format to a function performed by respective second and third applications. Similarly, each of the second and third adapters may transform a function performed by respective second and third applications to a function having a generic format and the first adapter may transform the function having the generic format to a function performed by the first application.

The first adapter, the second adapter and the third adapter may each be software operable upon a computer system hosting the corresponding application. The first application may be a core application, and one or both of the second and third applications may be a legacy application. However, another of the second and third applications may also comprise a core application.

The applications may be a portion of an enterprise system, such as an enterprise providing healthcare services. The applications may be case management applications, credentialing applications, financial applications, membership management applications, commissions applications, customer service applications, provider network management applications, claims processing applications, a group of the applications providing claims adjudication and/or the like. By way of example, the first application may be a claims adjudication application and the second and third applications may be different case management applications. Additionally, the first application my be a core claims adjudication application, the second application may be a legacy case management application and the third application may be a core case management application. As another example, a central case management application can interact with multiple claims adjudication engines, such as may have been previously associated with other healthcare services providers, or the like.

The adapters may provide the communication in the adapter common communication bus format using a web services module, a messaging module, a publishing module, and/or the like. The adapters may comprise a layered architecture, wherein an application interface layer provides the communication with the respective application, a business logic layer provides arbitration of particular business processes into objects for fulfilling functions supported by respective ones of the applications, and a communication layer provides the communication in the adapter common communication bus format. The communication layer might include a web services module and an information publishing module and support both real-time communication and batch communication.

Embodiments of the present invention may take the form of a computer program product having a computer readable medium with computer program logic recorded thereon for providing an interface adapter for interfacing a first type of application with an adapter of a second type of application, the computer program product. Each adapter may comprise an application interface layer in communication with the application, a business logic layer providing arbitration of business processes of the application into objects for fulfilling functions supported by the application, and a communication layer providing communications in a common communications format. The common communications format may be a common communication bus between adapters.

Communication with an application may be provided by a respective adapter, directly with the application or communication may be provided with a resource of the application, such as a database.

An embodiment of a method of the present invention includes passing information to be communicated from a first application through a first interface adapter. The first adapter preferably comprises a business logic. This business logic preferably transforms the information into a standardized information object understandable to a plurality of other interface adapters. The method also includes passing the information from the first application through one of a set of the other interface adapters. Each of these other adapters include business logic, the business logic parses the information contained in the information object for inputting the information into an application associated with the adapter.

The method embodiment further includes passing information to be communicated from one of the applications associated with the plurality of interface adapters. The business logic of the one of the plurality of interface adapters transforms the information into a standardized information object understandable to a plurality of other interface adapters. Finally, the method passes the information from the one other application through the first interface adapter business logic. The business logic of the first interface adapter parsing the information as contained in the information object for inputting in the first application.

The business logic may provide a standardized function object understandable to a plurality of interface adapters, the function object providing information with respect to a business process to be accomplished using the information object.

The adapters might include an application interface that converts the information from a format native to the associated application to a format common to a plurality of interface adapters, such as an extensible markup language.

Each adapter might include a communication interface that communicates the information object to another interface adapters in real-time or in batch mode or the information object may be published for acquisition by another interface adapter(s).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a high level block diagram of a portion of an enterprise system adapted for inter-application information communication according to an embodiment of the present systems and methods;

FIG. 2 shows additional detail with respect to an embodiment of adapters as shown in FIG. 1; and

FIG. 3 is a block diagram of a portion of an example healthcare services enterprise system adapted for information communication between a plurality of case management systems and a single adjudication application, in accordance with an embodiment of the present systems and methods.

### DETAILED DESCRIPTION

Embodiments of the present systems and methods are directed to using an adapter that is associated with a first software application, such as a claim processing software application, to enable the first software application to interact with a plurality of different applications of a second type, such as a plurality of different types of case management software applications that may be implemented within an insurer's organization. Similarly, an adapter associated with a single case management application may interact with a plurality of claims adjudication applications implemented within an insurer's organization using embodiments of the present adapters.

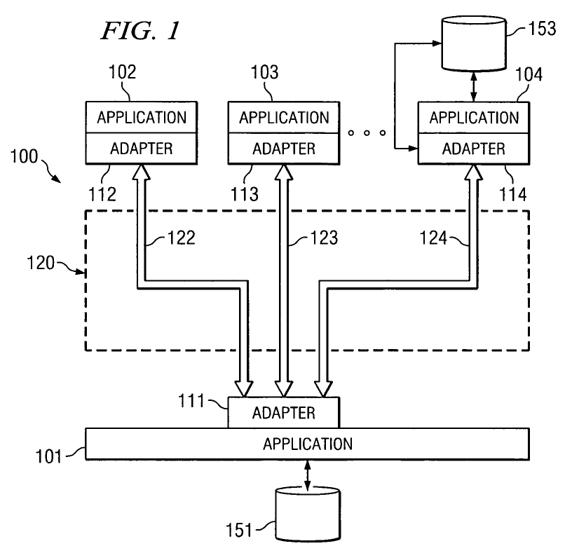

Directing attention to FIG. 1, a high level block diagram of enterprise system 100 in which interfaces are provided between disparate applications using a decentralized adapter architecture according to an embodiment of the present invention is shown. Enterprise system 100 of FIG. 1 includes a plurality of applications, shown here as applications 101-104. Applications 101-104 may provide various functions useful to the operation of an enterprise and may include multiple applications providing the same or similar functions, applications providing various aspects of particular functions, or the like. For example, where an enterprise associated with enterprise system 100 provides healthcare services, applications 101-104 may comprise one or more managed care payer administration application, case management application, credentialing application, financial application, claim processing application, etcetera. Applications 101-104 may utilize a number of different resources, such as database 151 associated with application 101 and database 153 associated with application 104, in providing the aforementioned functions.

Interfaces are provided between applications 101-104 according to the illustrated embodiment using adapters 111-114. As shown in FIG. 1, adapters 111-114 are associated with one or more information communication links, ones of which are illustrated as links 122-124, providing inter-application communication. Accordingly, a plurality of adapters and one or more links therebetween provide an interface between applications according to the illustrated embodiment. It should be appreciated, therefore, that an interface is not limited to a single link and corresponding adapters. Likewise, adapters are not limited to use with respect to a single link.

Adapters of embodiments of the present invention comprise instruction sets (e.g., software code) operable upon a processor based system. For example, an adapter of an embodiment of the present invention comprise one or more software modules operable upon a host system (e.g., server system) upon which an associated application is operable.

Adapters 111-114 of preferred embodiments are adapted to interact with one or more of applications 101-104 and therefore include logic for facilitating input and/or output of information from associated ones of applications 101-104. For example, each adapter of an embodiment is adapted for proprietary data communication with an associated application of applications 101-104, thereby providing information communication suitable for establishing an end of an inter-application interface. Such proprietary data communication may include protocols, data formats, signaling, etcetera unique to interaction with the associated application. Additionally or alternatively, adapters 111-114 may be adapted to interact with resources of an associated application. For example, adapters of embodiments of the present invention interact with a database of an associated application, such as databases 151 and 153, to facilitate information communication between applications. Such interaction with these resources may be to obtain data for information communication, to determine a time and/or content of information communication, etcetera.

Each of adapters 111-114 of preferred embodiments are adapted to communicate with any of adapters 111-114. For example, each of links 122-124 of preferred embodiments implement a same or common information communication protocol, thereby providing common communication bus 120 to facilitate communication between any and all of adapters 111-114. According to a preferred embodiment of the present invention, adapters 111-114 use an open or standardized protocol, such as XML, SOAP, WSDL, UDDI, etcetera, and combinations thereof, for the foregoing communications. For example, adapters 111-114 may use web services protocol, comprising a combination of XML, SOAP, WSDL, and UDDI, for inter-adapter communications.

It should be appreciated that common communication bus 120 of embodiments of the present invention may utilize any of a number of physical media for information communication. For example, where applications of enterprise system 100 are operable within a same host computer, common communication bus 120 may utilize data busses of the computer system for information communication as described herein. As another example, where applications of enterprise system 100 are operable upon different host computers, common communication bus 120 may utilize network (e.g., local area network (LAN), metropolitan area network (MAN), wide area network (WAN), intranet, extranet, the Internet, public switched telephone network (PSTN), cable transmission, satellite) or other data links for information communication as described herein.

Common communication bus 120 of the illustrated embodiment facilitates creation of and modification to interfaces between applications 101-104. For example, because each of adapters 111-114 are capable of communicating with any other of adapters 111-114, through common communication bus 120, new links may readily be added to or replace links 122-124 to provide a new or different interface. Likewise, adapters may be readily added to enterprise system 100 to provide new and different interfaces between an added adapter and one or more of adapters 111-114. Additionally or alternatively, when it becomes desirable to replace any of adapters 111-114, such as when any of applications 102-104 are removed or consolidated, common communication bus 120 facilitates any desired adapter replacement without the need to alter any other adapters or links of enterprise system 100.

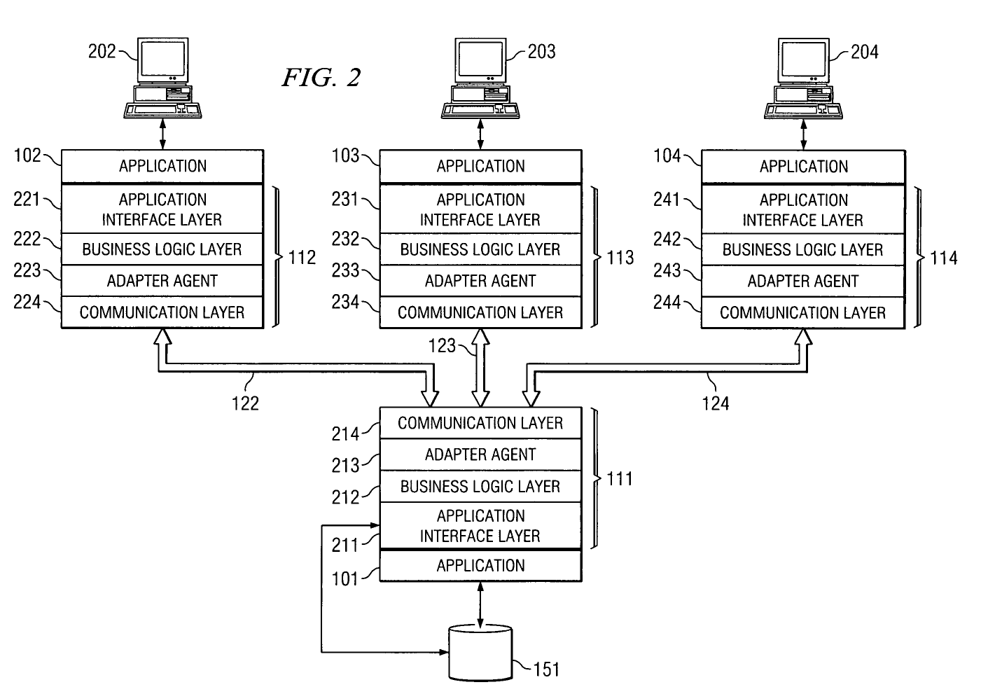

FIG. 2 shows additional detail with respect to adapters utilized in providing an interface between applications according to an embodiment of the present invention. Specifically, detail with respect to adapters 111-114, providing interfaces between application 101 and applications 102-104, of FIG. 1 are shown in FIG. 2. Applications 102-104 may be of a particular type which may be accessed via terminals 202, 203 and 204. By way of example, in a healthcare insurance environment, application 101 may be a claim processing software application or claim adjudication engine, and applications 102-104 different case management software applications that may be implemented within an insurer's organization. Conversely, application 101 may be a case management software application, and applications 102-104 different claim processing software applications or claim adjudication engines that may be implemented within an insurer's organization. The different case management applications or claim processing software applications may be in place due to acquisition or merger of insurers, or other reasons. Terminals 202-204 may also be associated with databases. For example, terminal 203 may be associated with database 153 of FIG. 1.

As can be seen in the exemplary configuration of FIG. 2, adapters of embodiments of the present invention comprise a layered configuration. Specifically, in the illustrated embodiment adapter 111 comprises layers 211-214 and adapter 112 comprises layers 221-224, corresponding to an application interface layer, a business logic layer, an adapter agent layer, and a communication layer, respectively, interacting to provide functionality as described herein. Similarly, each of adapters 113 and 114 comprises layers 231-234 and 241-244, respectively, corresponding to an application interface layer, a business logic layer, an adapter agent layer, and a communication layer, respectively. Alternative embodiments of the invention may include more or fewer layers (including a single layer), and layers thereof may provide functionality in addition to, or in the alternative to, that described with respect to the illustrated embodiment.

An application interface layer, e.g., application interface layers 211, 221, 231 and 241, of various embodiments provides arbitration between an associated application's proprietary input/output format and data structure and a data structure of the common communication bus. For example, application interface layer 211 may facilitate interaction with application 101 to identify particular information within the application, to input and/or extract appropriate information, and to convert information between a proprietary format of application 101 and a format of common communication bus 120. Application interface layer 211 may input and/or extract the foregoing information from resources of application 111, such as database 151, in addition to, or in the alternative to, interacting directly application 111, if desired.

A business logic layer, e.g., business logic layers 212, 222, 232 and 242, of various embodiments provides arbitration of particular business processes into objects for fulfilling functions supported by adapters of embodiments of the present invention. Adapters of embodiments of the invention are associated with an enterprise function or “business process.” Accordingly, embodiments of the present invention provide adapters 111-114 for particular business processes or functions facilitated using one or more of applications 101-104. In accordance with the present invention adapters 112-114 are provided for a particular type of business process or function facilitated using respective ones of applications 102-104. In operation, a business logic layer of a preferred embodiment receives data in a standard format (either from an application via an application interface layer or from another adapter via a communication layer), determines what part of that data is to be ignored and which part of that data is to be used for the business process as implicates the interface provided, transforms that portion of data as suitable for providing to an application or another adapter to accomplish the business process. A particular business process may implicate particular information associated with a plurality of applications. A business logic layer of embodiments of the present invention will identify the information implicated, the applications associated with the information, and steps or a process used to implement the business process as between the plurality of applications to appropriately exchange information using the aforementioned objects. For example, a healthplan may utilize a Provider Information Management System (PIMS) to maintain information about providers (physicians and facilities) that participate in the healthplan's provider networks. In accordance with embodiments of the present invention, each time a provider is added, changed, or deleted in the PIMS it may be desirable to distribute the provider transaction to the network claims adjudication application(s), case management application(s) and credentialing applications(s).

Business logic layers of embodiments of the invention may additionally provide routing information, such as to indicate that an information object is to be published and/or to identify one or more adapters or applications to which information objects are to be communicated. Routing information may be determined based upon various criteria, such as the information content, the business process being performed, the particular function, etcetera. Such routing information may identify adapters and/or applications by a class, type, or a function performed. Alternatively, such routing information may specifically identify a particular adapter or application. In accordance with the present invention, business logic layers 222, 232 and 242 of adapters 112-114 may indicate that information is to be routed to application 101 and/or adapter 111. However, embodiments may implement an information object routing technique which does not rely upon identification of particular adapters or applications to which such information is to be routed. For example, a business logic of an adapter, such as adapter 101, may be “self aware” of the functions supported thereby and thus may consume information objects having an associated function object for which functions are supported by the adapter, such as information objects provided by adapters 112-114.

The objects utilized by business logic layers of an embodiment are preferably standardized to facilitate predictable interaction between adapters. Objects utilized according to embodiments of the invention define the type of information that the adapter will be transforming, types of methods that the adapter will perform, etcetera. For example, an information object may be defined as “member” having an information structure including information for a member (e.g., name, address, phone number, account number, etcetera) stored by an associated application. Similarly, an information object may be defined as “transaction” having an information structure which includes information for a transaction (e.g., member name, service provider, date of services, type of services, etcetera) stored by an associated application. Additionally, a function object may be defined as “delete” which includes steps associated with a record deletion in an associated application.

Although any number and type of objects may be utilized according to embodiments of the invention, objects used are preferably shared among adapters. For example, each adapter associated with applications for which member information is stored may implement a “member” information object, although the actual information (in content and the fields included in the structure) may vary from application to application. Likewise, each adapter associated with applications for which particular functions (e.g., delete, add, update, final, etcetera) are to be invoked have a corresponding function object, although the particular steps performed by the function objects may vary from application to application. Accordingly, objects of preferred embodiments operate to convert information between a generic information structure and a structure utilized by a business process in a particular application (information objects) and to convert generic functions to functions utilized by a business process of a particular application (function objects). In view of the above, the data and the functions (e.g., delete, add, etcetera) are transformed between an application-specific format to a generic format. Further, the functions (business logic) to be implemented in a given adapter may be selected on a per business process (or “business cycle”) basis, as described further herein.

In operation according to embodiments of the invention, a business logic layer, such as layer 212, transforms requests and other outputs of an application, such as application 101, provided in a standardized format by the associated application interface layer, such as layer 211, into standardized objects understandable to other adapters, such as to satisfy a request or otherwise appropriately consume the output. Similarly, a business logic layer, such as layer 212, transforms responses and other inputs to an application, such as application 101, provided in a standardized format by a corresponding interface layer (e.g., interface layers 221, 231 and 241) and/or as a standardized object by a corresponding business logic layer (e.g., business logic layer 222, 232 and 242), into information in the appropriate format understandable to the application (101), such as to provide a response to a previous request or otherwise appropriately use the input.

The foregoing business processes may be of various scales. For example, adapters of various embodiments of the present invention may be associated with business processes on a small or micro-scale, such as may include processes associated with a single data record, individual, transaction, or event. Micro-scale business processes of one embodiment include relatively simple processes such as add a new patient, add a new provider, change an address, query an individual's information, post a payment to an account, retrieve detail for a particular claim, and the like. Adapters of embodiments of the present invention may additionally or alternatively be associated with business processes on a large or macro-scale, such as may include processes associated with multiple data records, individuals, transactions, or events. Macro-scale business processes of one embodiment include relatively complex processes such as process claims, adjudicate claims, period end processing, import data, global updates, and the like.

The illustrated embodiment of FIG. 2 includes an adapter agent layer, e.g., adapter agent layers 213, 223, 233 and 243. Adapter agent layers of preferred embodiments facilitate monitoring and/or transaction logging. For example, an external logging/monitoring agent may communicate with adapter agent layers of each adapter validate that each such adapter is operating as well as to monitor transactions performed by the adapters. As discussed in greater detail in above incorporated U.S. patent application Ser. No. 10/965,253 entitled “INTERFACING DISPARATE SOFTWARE APPLICATIONS.” An adapter agent layer may be omitted from embodiments wherein monitoring and/or transaction logging is not desired.

A communication layer, e.g., communication layers 214, 224, 234 and 244, of various embodiments provides for communication with other adapters. Communication provided by the communication layers of preferred embodiments is in a same or common information communication protocol to provide a common communication bus, such as common communication bus 120 of FIG. 1. The foregoing common information communication protocol may be provided using a web services architecture. It should be appreciated that adding new or modified adapters to an enterprise system using adapters having a communication layer as illustrated, providing a common communication bus, is simplified due to each adapter communicating via the common communication bus. Accordingly, adapters may be readily added as new applications are added, changed or removed, and/or as business processes are added or changed.

Communication layers of embodiments of the invention may provide inter-adapter communication in a number of ways. For example, communication may be provided in real-time to establish a real-time interface between applications, such as may be useful in low-latency or no latency (e.g., interactive) processing of transactions or queries which involve multiple applications. Additionally or alternatively, communication may be provided in batch to establish a periodic interface between applications, such as may be useful in accumulated or high-volume processing of transactions or records which involve multiple applications.

Embodiments of the present invention employ communication layers which support various communication paradigms. For example, communication layers may implement a web services architecture to provide communication in response to requests (e.g., a request as issued by an associated application or adapter) and responses (e.g., a response to a previous request as issued by an associated application or adapter). Additionally or alternatively, communication layers may implement a publishing or messaging services architecture to push information to one or more destinations, such as upon the occurrence of an event, periodically, or based upon other triggers. Such information may be published directly to one or more consuming adapters or the information may be published to a data store, such as database 152 of FIG. 1, accessible to one or more consuming adapters.

Communications layers of embodiments of the present invention may include routing logic, such as to determine routing information. For example, rather than business logic layers of the invention providing routing information, as described above, communication layers of an embodiment may determine routing information to indicate that an information object is to be published and/or to identify one or more adapters or applications to which information objects are to be communicated. Alternatively, communications layers of embodiments of the invention may facilitate routing of information objects in accordance with routing information provided thereto.

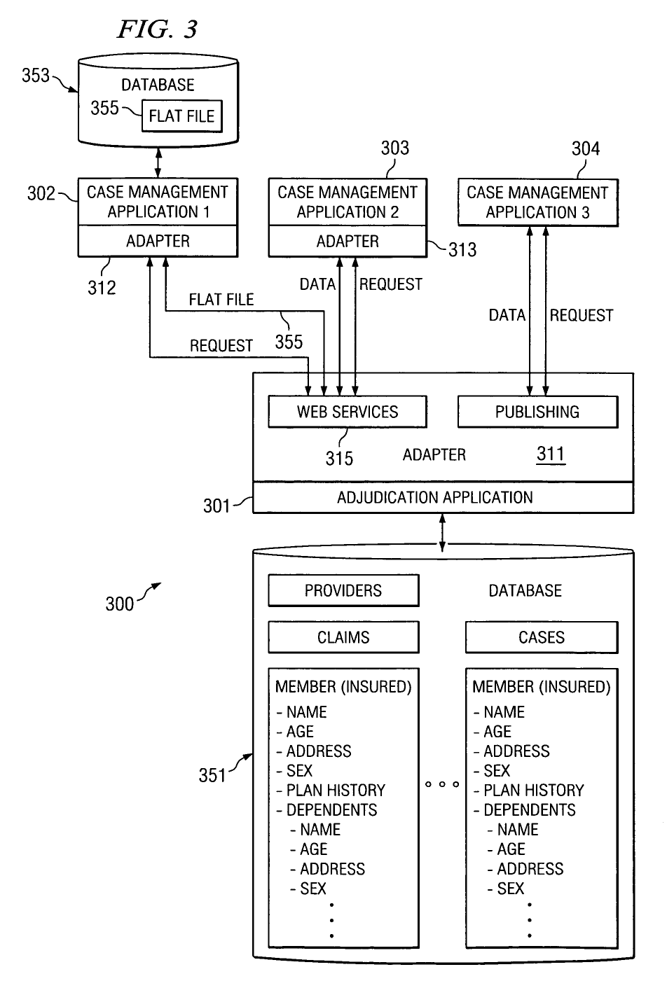

Having described the layers of a preferred embodiment adapter, their use with respect to an exemplary interface will be described with reference to FIG. 3. FIG. 3 is a block diagram of a portion of example healthcare services enterprise system 300 adapted for information communication between a plurality of case management systems, 302, 303 and 304 and a single adjudication application, 301 in accordance with an embodiment of the present systems and methods. A case management application (302, 303 or 304) may be an internally developed application, a commercially available application, or a developed application based on a commercially available application. Regardless, in accordance with the present invention a same adapter (311) will be used by a claims processing application 301 to interface with any of the case management applications and preferably other applications. FIG. 3 will be used to describe three different scenarios, through three differently configured case management applications 302, 303 and 304. This described example of FIG. 3 is but one example of business processes which may be provided inter-application interfaces in accordance with the present invention. For example, a central case management application can interact with multiple claims adjudication engines, such as may have been previously associated with other healthcare services providers, or the like using adapters in accordance with the present invention.

Each of applications 302, 303 and 304 are adapted to make calls for data or instructions from some other system. Adapters 312, 313 and 314 are adapted to conform the calls for data or instructions into a common format which may be used by adapter 311 to communicate the call for data or instructions to application 301 which may then retrieve and supply the data or instructions to application 302, 303 or 304 by providing the data to adapter 311 which conforms it to a common format which may be which may be used by adapter 312, 313 or 314 to communicate the data or instructions to application 302, 303 or 304, respectively.

In a first example, adapter 311 associated with application 301 interacts directly with adapter 312, associated with application 302. For example, a business logic layer of adapter 312 might provide routing information which will direct information or a query from application 302 to adapter 311 of application 301. Adapters 311 and 312 may employ web services 315, employing one or more protocols, including XML, SOAP, WSDL, and/or UDDI, for “direct” inter-adapter communications. Case management application 302 may be an application which using data stored locally, such as database 353. This database may reside on a server or terminal running application 302. This data may be provided in a “flat file format,” which is copied to storage for use by application 302 in a local manner. Thus, application 302 will typically not need to make further calls to application 301 for further data, since any data application 302 would need would have been “published” to it in flat file 355.

Application 303 may not employ locally stored data but rather us data from a central location, such as illustrated database 351. Data may be provided to application 303 via a queue. Thus application 301 may provide application 303 only base data and application 303 might “drill-down” for additional data it needs by interacting with the queue. Therefore, in the present health care insurance example in order to determine the names and ages of dependents a call may be made by application 303, via adapters 313 and 311 to application 301 to obtain the dependent and age and attributes associated with the member. Since application 303 has no use for all of the data in a flat file, only the information requested is called for by case management adapter 313. Furthermore, when integrating disparate applications it may be desirable to avoid storing the same data in multiple systems. Storing the same data in multiple systems may introduce data integrity and data synchronization issues. Here, a source application adapter may publish minimal data, such as keys or ID's that can be used later to lookup additional information and possibly a small set of descriptive elements, for consumption by other applications, via their adapters. In this manner the minimal data might be, by way of example, just enough information about a member, provider or the like so that an application can make an on-demand call to the source application, via their associated adapters for additional detail for the member, provider or the like.

The business logic layer and/or communication layer of adapter 313 preferably initiates a real time call in a common format, such as a web service protocol, asking for desired data. Adapter 311 communicates the data request to application 301, which may provide more data than was requested by application 303. However, when this data is communicated back to adapter 313, the business logic layer of adapter 313 preferably filters out any unrequested data and provides the requested data to application 303, via adapter 313's application interface layer.

Case management application 304 may be capable of employing data in the one or more formats published by adapter 311 of application 301. Therefore. Application 304 may not employ an adapter. Case management application 304 might make a call, such as a real time call, to application 301, via adapter 311 in an open or standardized protocol used by adapter 311 (and adapters 312 and 313, and the communication bus (120)). Application 301 provides this information via adapter 311, which publishes the information for consumption by application 304, directly.

The flow of data in system embodiment 300 will now be described in somewhat greater detail with reference to FIG. 3 and the layers of FIG. 2. Data may be provided from any of applications 302, 303, 304 to application 301 using the present adapters. Data input in case management application 302 or 303 is provided to respective adapter 312 or 313, via the adapters application interface layer, in a format native to the application. Adapter 312 or 313 then employs its business logic layer to translate the data into a an open or standardized protocol common to the adapters. The communication layer of the respective adapter then communicates the data to adjudication application 301, via adapter 311. Case management application 304 might provide data directly to adapter 311 in a an open or standardized protocol. The communication layer of adapter 311 receives/captures the data, such as via web services 315. The business logic layer of adapter 311 then translates the data into a format usable by application 301 and the application interface layer of adapter 311 provides the data to application 301. Application 301 may then make appropriate use of the data such as storing it in database 351.

A resulting example of an exchange between one of applications 302, 303 or 304 might include the following, in which a new member is added via one of case management systems 302, 303 or 304 to adjudication application 301. A user may input a new member's name, address, age, telephone number, weight, height, etcetera through a user interface of application 302, 303 or 304. As another example, to add a new provider in a PIMS a user might input a physician's name, tax ID, office location, specialties, and/or the like. The user may desire that corresponding new member or physician records be created in one or more other applications of enterprise system 100, such as in claim system application 301. Accordingly, an inter-application interface of embodiments of the present invention is invoked to provide the proper information to appropriate applications, such as application 301, as well as to perform the appropriate functions to achieve creation of the new record and populate the appropriate fields with information.

Adapter 312 or 313, associated with application 302 or 303, wherein the user has created the new member record, operates to provide information to a corresponding adapter, such as adapter 311 associated with application 301. For example, the adapter's application interface layer, under control of business logic layer, may monitor a resource associated with application 302, such as a database 353, to recognize that an event associated with the business process for which adapter 312 is responsible has transpired (e.g., the appearance of a new member record). Additionally or alternatively, application interface layer of adapter 312 or 313, may monitor output of respective application 302 or 303 to determine that inter-application communications are to be conducted. For example, application 303 may output new member information, perhaps under control of the user, for creating corresponding records in other applications. Although application 303 may have the capability to output information for updating other applications, application 303 of the illustrated embodiment does not possess the ability to provide the information in the appropriate format, is unaware of which other applications are to receive the corresponding update, and does not know the particular functions to invoke to achieve an appropriate update by such applications. Accordingly, adapter 313 may provide such functionality.

Having determined that an event has transpired, or otherwise having determined that inter-application communications are to be performed, the application interface layer obtains the appropriate information from the associated application and/or its associated resources, such as database 353 and converts the information to a generic format of the common communication bus (120). For example, the application interface layer may cooperate with business logic layer to identify the particular information available from application 302 and/or database 353 for use in an associated business process, such as adjudication application 301. The identified information may be obtained by the application interface layer and converted to a format of common communication bus by the business logic layer forming an information object. For example, in the add member example, the new member's name, address, age, telephone number, weight, height, etcetera may be obtained, and in the example adding a new provider in a PIMS, the physician's name, tax ID, office location, specialties, etcetera may be obtained, although one or more consuming application may use only a portion of this information in either example. Accordingly, the information object created is adapted to be utilized by a number of different applications (including applications which are later modified or added) without modification to the adapter.

The business logic layer may also operates to determine any function objects to be associated with the information in order to facilitate the business process at an interfaced application. In the new member example, the business logic layer might associate an “add” function object with the information object. Business logic layer might also identify corresponding applications or their interfaces to which the objects apply, such as by indicating a business process the information object (or objects) and function object (or objects) is to accomplish.. All the foregoing information may be passed to a communication layer of adapter 312 or 313 for communication via the common communication bus (120) to adapter 311.

Using information identifying corresponding applications or their interfaces provided by the business logic layer, the communication layer preferably communicates the information objects and function objects to appropriate destinations. For example, where the information is not real-time, communication layer may publish the objects directly to adapter 311 or a published information database for later retrieval by adapter 311. Where the information is real-time, the communication layer preferably communicates the objects directly to adapter 311 for real-time updating of database 353 of this example. Additionally or alternatively, the communication layer may place the information objects and function objects on the common communication bus (120) for the appropriate adapters to recognize this information as being relevant to their functions and consume the information accordingly.

The layers of adapter 311 essentially work in the reverse of that described above with respect to the layers of adapters 312 and 313. For example, the communication layer of adapter 311 obtains the objects communicated by the communication layer of adapter 312 or 131, such as directly from the communication layer of adapter 312 or 313 or from a published information database. The communication layer of adapter 311 may obtain data directly from case management application 304. The business logic layer of adapter 311 may analyze the function objects to determine what business operation is to be performed and use its business logic to determine the steps associated with the business operation as well as the particular information within the information objects relevant to application 103 in this business operation. Adapter 311 's application interface layer converts the information and the function steps into the format and steps specific to accomplishing adding the new member to application 301 and/or database 351. The information may be provided to application 301 for further processing and/or dissemination or the data may be provided directly to one or more resources of application 301, such as database 351, by the application interface layer.

Although adding a member of this example has been described with reference to information flowing from application 302, 303 or 304 to application 301, it should be appreciated that such information may flow bi-directionally as well as uni-directionally. For example, application 301 may provide responsive information which passes through the layers of adapter 311 and adapter 312 or 313 to application 102 or 303. Similarly, adapter 311 may provide responsive information to adapter 312 or 313, such as to confirm the update, to request additional information, etcetera.

Thus the present systems and methods provide a broad spectrum of information, in various formats, and enables each individual application, through its associated adapter to determine which information to retain and how to present it to the application.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A system comprising:
a first adapter providing communication with a first application in a format native to said first application and further providing communication in an adapter common communication bus format;
a second adapter providing communication with a second application in a format native to said second application and further providing communication in said adapter common communication bus format, said second application being of a type differing from said first application; and
a third adapter providing communication with a third application and further providing communication in said adapter common communication bus format, said third application being of a type similar to said second application.

2. The system of claim 1, wherein said first application comprises a core application, and one of said second and third applications comprises a legacy application and another of said second and third applications comprises a core application.

3. The system of claim 2, wherein said first adapter transforms a function performed by said first application to a function having a generic format, and each of said second and third adapters transforms said function having said generic format to a function performed by respective second and third applications.

4. The system of claim 2, wherein each of said second and third adapters transform a function performed by respective second and third applications to a function having a generic format and said first adapter transforms said function having said generic format to a function performed by said first application.

5. The system of claim 1, wherein said first adapter, said second adapter and said third adapter each comprise software code operable upon a computer system hosting a respective one of said first application, said second application and said third application.

6. The system of claim 1, wherein said applications comprise at least a portion of an enterprise system.

7. The system of claim 6, wherein an enterprise using said enterprise system comprises an enterprise providing healthcare services.

8. The system of claim 7, wherein said first application is of a type selected from the group consisting of:
a case management application;
a credentialing application;
a financial application;
a membership management application;
a commissions application;
a customer service application;
a provider network management application;
a claims processing application; and
a group of said applications providing claims adjudication.

9. The system of claim 8, wherein said type of said second and third applications are selected from the group consisting of:
a case management application;
a credentialing application;
a financial application;
a membership management application;
a commissions application;
a customer service application;
a provider network management application;
a claims processing application; and
a group of said applications providing claims adjudication.

10. The system of claim 1, wherein said first application is a claims adjudication application and said second and third applications are different case management applications.

11. The system of claim 10, wherein said first application comprises a core claims adjudication application, said second application comprises a legacy case management application and said third application comprises a core case management application.

12. The system of claim 1, wherein said first application is a case management application and said second and third applications are different claims adjudication applications.

13. The system of claim 12, wherein said first application comprises a core case management application, said second application comprises a legacy claims adjudication application and said third application comprises a core claims adjudication application.

14. The system of claim 1, wherein said adapters provide said communication in said adapter common communication bus format using a web services module.

15. The system of claim 1, wherein said adapters provide said communication in said adapter common communication bus format using a messaging module.

16. The system of claim 1, wherein said adapters provide said communication in said adapter common communication bus format using a publishing module.

17. The system of claim 1, wherein said adapters comprise a layered architecture.

18. The system of claim 17, wherein said layered architecture of each of said adapters comprises an application interface layer providing said communication with the respective application.

19. The system of claim 17, wherein said layered architecture comprises a business logic layer providing arbitration of particular business processes into objects for fulfilling functions supported by respective ones of said applications.

20. The system of claim 17, wherein said layered architecture comprises a communication layer providing said communication in said adapter common communication bus format.

21. The system of claim 20, wherein said communication layer comprises a web services module and an information publishing module.

22. The system of claim 20, wherein said communication layer supports both real-time communication and batch communication.

23. The system of claim 1, wherein said communication with one of said applications is provided by a respective one of said adapters, directly with the one application.

24. The system of claim 1, wherein said communication one of said applications is provided by a respective one of said adapters, directly with a resource of the one application.

25. The system of claim 24, wherein said resource of said one application comprises a database.

26. A method comprising:
passing information to be communicated from a first application through a first interface adapter comprising business logic, said business logic of said first interface adapter transforming said information into a standardized information object understandable to a plurality of other interface adapters;
passing the information from said first application through one of a set of said plurality of interface adapters, each adapter of said set of adapters comprising business logic, said business logic of said one adapter of said set of adapters parsing said information as contained in said information object for inputting in an application associated with said one of said set of adapters;
passing information to be communicated from one of said applications associated with said set of said plurality of interface adapters, said business logic of said one of said plurality of interface adapters transforming said information into a standardized information object understandable to a plurality of other interface adapters; and
passing the information from the one application through said first interface adapter business logic, said business logic of said first interface adapter parsing said information as contained in said information object for inputting in said first application.

27. The method of claim 26, further comprising:
providing, by said business logic of said first interface adapter, a standardized function object understandable to a plurality of interface adapters, said function object providing information with respect to a business process to be accomplished using said information object.

28. The method of claim 26, wherein said first interface adapter comprises an application interface, said method further comprising:
converting, by said application interface, said information from a format native to said first application to a format common to a plurality of interface adapters, said plurality of interface adapters including said first interface adapter, said second interface adapter, and a third interface adapter.

29. The method of claim 28, wherein said common format comprises an extensible markup language.

30. The method of claim 26, wherein said first interface adapter comprises a communication interface, said method further comprising:
communicating, by said communication interface, said information object to said one of said set of said plurality of interface adapters in real-time.

31. The method of claim 26, wherein said first interface adapter comprises a communication interface, said method further comprising:
communicating, by said communication interface, said information object to said one of said set of said plurality of interface adapters in a batch mode.

32. The method of claim 26, wherein said first interface adapter comprises a communication interface, said method further comprising:
publishing, by said communication interface, said information object for acquisition by said one of said set of said plurality of interface adapters.

33. The method of claim 26, wherein each of said plurality of interface adapters are associated with a particular business process.

34. The method of claim 26, wherein each of said plurality of interface adapters are associated with a particular business process accomplished using said first application and said plurality of interface adapters.

35. A computer program product having a computer readable medium having computer program logic recorded thereon for providing an interface adapter for interfacing a first type of application with an adapter of a second type of application, said computer program product comprising:
an application interface layer in communication with an application associated with said interface adapter;
a business logic layer providing arbitration of business processes of said application into objects for fulfilling functions supported by said application; and
a communication layer providing communications in a common communications format.

36. The computer program product of claim 35, wherein one application of said first and second types of applications comprises a legacy application and the another one of said applications of said first and second types of applications comprises a core application.

37. The computer program product of claim 35, wherein one application of said first and second types of applications comprises a legacy application and the another one of said applications of said first and second types of applications comprises an added application.

38. The computer program product of claim 35, wherein said application interface layer is in communication with a first application of said first type of said applications.

39. The computer program product of claim 35, wherein said communications layer uses a communication format common with said adapter of a second type of application.

40. The computer program product of claim 39, wherein said common format comprises a common communication bus between adapter and said adapter of a second type of application.

41. The computer program product of claim 35, wherein said business logic layer provides arbitration of particular business processes into objects for fulfilling functions supported by an application of said a first type of application.

42. The computer program product of claim 41, wherein said objects comprise information objects.

43. The computer program product of claim 42, wherein said information objects define the type of information that the first adapter will be transforming.

44. The computer program product of claim 41, wherein said objects comprise function objects.

45. The computer program product of claim 44, wherein said function objects define the types of methods that the first interface adapter will perform.

46. The computer program product of claim 35, wherein the first interface adapter has an adapter agent layer.

47. The computer program product of claim 46, wherein said adapter agent layer facilitates at least one of monitoring operation of an interface provided by said adapter and logging of transactions conducted via said adapter.

48. The computer program product of claim 35, wherein said communication layer comprises a web services module and an information publishing module.

49. The computer program product of claim 35, wherein said communication layer supports both real-time communication and batch communication.
